(19) United States
(12) Patent Application Publication
(10) Pub. No.: US 2008/0030748 A1
(43) Pub. Date: Feb. 7, 2008

(54) IMAGE PROCESSING METHOD AND DISPLAY SYSTEM UTILIZING THE SAME

(75) Inventors: Yuan-Hung Wang, Miaoli County (TW); Sheng-Hung Lin, Taichung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WISEPAL TECHNOLOGIES, INC., Miao-Li County (TW)

(21) Appl. No.: 11/551,838

(22) Filed: Oct. 23, 2006

(30) Foreign Application Priority Data
Jul. 24, 2006 (TW) 95126908

(51) Int. Cl. G06K 15/02

(52) U.S. Cl. 358/1.2

(57) ABSTRACT

An image processing method and a related image display system. A video signal with original data items of original dots is received, all the original dots constructing one line of an image. The original data items are processed to perform a zoom function and generate processed data items, which are then written to the memory units of a buffer. Before all the processed data items are written to the memory units, the processed data items stored in the memory units are sequentially read to drive corresponding dots in a line on a display. The time when all the processed data items stored in memory units have been read ends at substantially the same time as that when all the processed data items have been written to memory units.

### BACKGROUND OF THE INVENTION

1. Field of the Invention

The invention relates to image processing, and particularly to a method and system utilizing little memory.

2. Description of the Related Art

Increased aspect ratios such as 16:9 have become popular in display technology, such that most current liquid crystal display televisions utilize a 16:9 panel. Correspondingly, portable video devices, such as digital cameras and digital video recorders, have begun to provide 16:9 LCD panels.

In order for a 16:9 panel to support display of video content in a 4:3 format with acceptable or negligible distortion, the content must be first processed.

FIG. 1 shows, on the left, a 4:3 resolution image and, on the right, a 16:9 panel displaying the image. One method of displaying a 4:3 resolution image on a 16:9 panel is to zoom (or proportionally enlarge) the 4:3 resolution image until the height matches the height of the 16:9 panel, although the zoomed image remains narrower than the 16:9 panel, two portions of which are thus not driven. Conventionally a predetermined color, such as black or blue, is displayed in the two undriven portions of the panel, as shown in FIG. 1. The two portions are referred to as frame borders.

If a 4:3 resolution image has 1440 dot data items per line and each line of a 16:9 panel has 960 dots per line, for example, then only the central 720 dots in one line on the panel are used to correspond to 1440 dot data items per line in the image, and the other 120(=(960−720)/2) dots in one line in each of the two frame borders constantly display a fixed color of black.

Generally, a 4:3 resolution image is input line-by-line into a video device. Zooming of the image and providing a fixed color for frame borders can de-synchronize input of the original data items for original dots in a line with the driving of processed data items for corresponding dots in a corresponding line of a panel. Thus, a video device requires a buffer to temporarily store the processed data items.

Some video devices comprise frame buffers, each buffering an entire image for display on a 16:9 panel. Processed data items, following the variations of original data items, are constantly updated in corresponding areas of the frame buffer, while the areas corresponding to frame borders remain unchanged due to the lack of variation in the single-color data. This architecture has an advantage of simple design since writing to the buffer memory units may be independent from reading of the memory units. However, higher product costs are incurred, especially for portable devices since the minimum size of the frame buffer is the total dot number in a 16:9 panel.

Since conventional LCD panels are driven or scanned line-by-line, two line buffers have been used to buffer processed data items, representing a considerable reduction in required buffer memory. FIGS. 2A and 2B illustrate writing and reading of line buffers 10 and 12 during two consecutive line periods. As shown, during a line period, line buffer 10 or 12 outputs processed data items stored therein to drive a panel line preceding another line whose processed data items are currently written or buffered into the other line buffer. Writing and reading to the two line buffers are thus separated. However, even if the line buffers are not required to buffer the fixed data items for frame borders, each line buffer must buffer at least the processed data items driving corresponding dots display, in one line of an image. In other words, the minimum size of each line buffer must be the same size of the panel dots in a line affected by an image. Thus, when displaying a 4:3 resolution image with 1440 dots per line on a 16:9 panel with 960 dots per line, each line on the panel has 720 dots corresponding to one line of the image, such that each of the two line buffers must comprise at least 720 memory units if each stores one processed data item.

Reducing buffer size, accordingly, lowers costs and bolsters competitive market behavior.

### BRIEF SUMMARY OF THE INVENTION

The invention provides an image processing method, in which a video signal with original data items of original dots is received, the original dots constructing one line of an image. The original data items are processed to execute a zoom function and generate processed data items, which are then written to memory units. Before all the processed data items are written, the processed data items stored in the memory units are sequentially read to drive corresponding dots in a line on a display. The time of reading all the processed data items stored in the memory units ends substantially at the same time as that when all the processed data items have been written to the memory units.

The invention further provides an image display system comprising a display, a buffer, a processing unit, and a display driver. The display has lines with dots. The buffer comprises memory units. The processing unit receives a video signal with original data items of original dots, processes the original data items to perform a zoom function and generate processed data items, and writes the processed data items to the memory units, wherein all original dots construct one line of an image. The display driver sequentially reads the processed data items stored in the memory units to drive corresponding dots in a corresponding line on the display. The number of all the processed data items exceeds the number of the memory units.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows on the left a 4:3 resolution image and on the right a 16:9 panel displaying the image;

FIGS. 2A and 2B illustrate writing and reading of line buffers 10 and 12 during two consecutive line periods;

FIG. 3 illustrates an image display system according to embodiments of the invention;

FIG. 4 shows on the left a 4:3 resolution image with 1440 (dot) data items per line and on the right a 16:9 display with 960 dots per line;

FIG. 5 is a timing diagram for signals according to embodiments of the invention;

FIGS. 6A to 6G show at different clocks a buffer with only 360 memory units while 720 processed data items require storage;

FIG. 7 is another timing diagram for signals according to embodiments of the invention; and

FIG. 8 shows a display applicable with the invention.

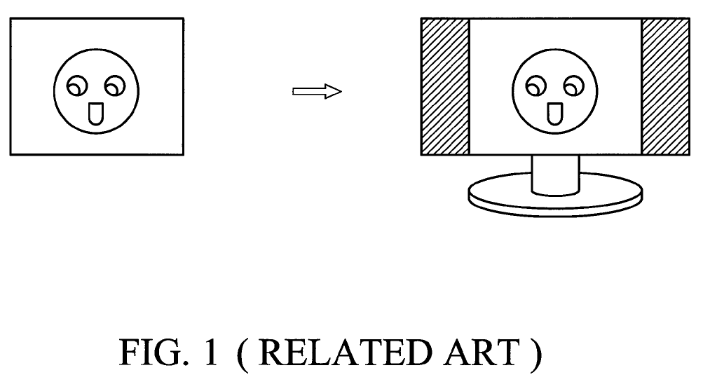

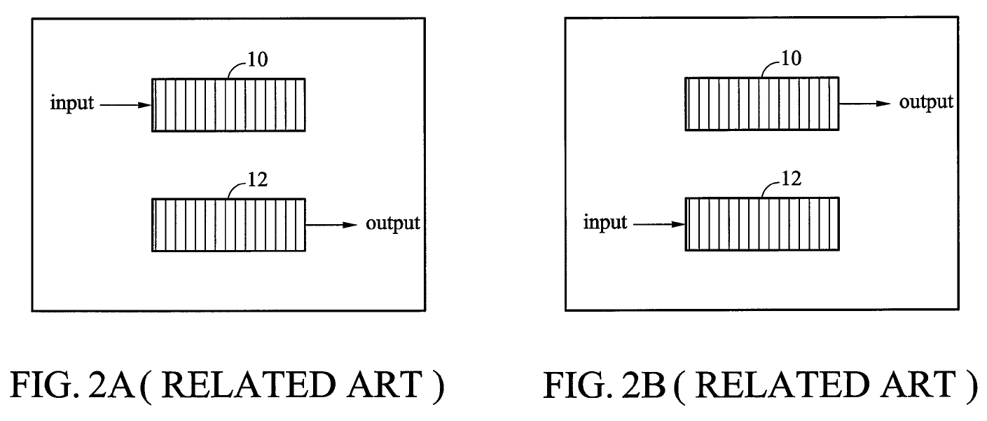

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

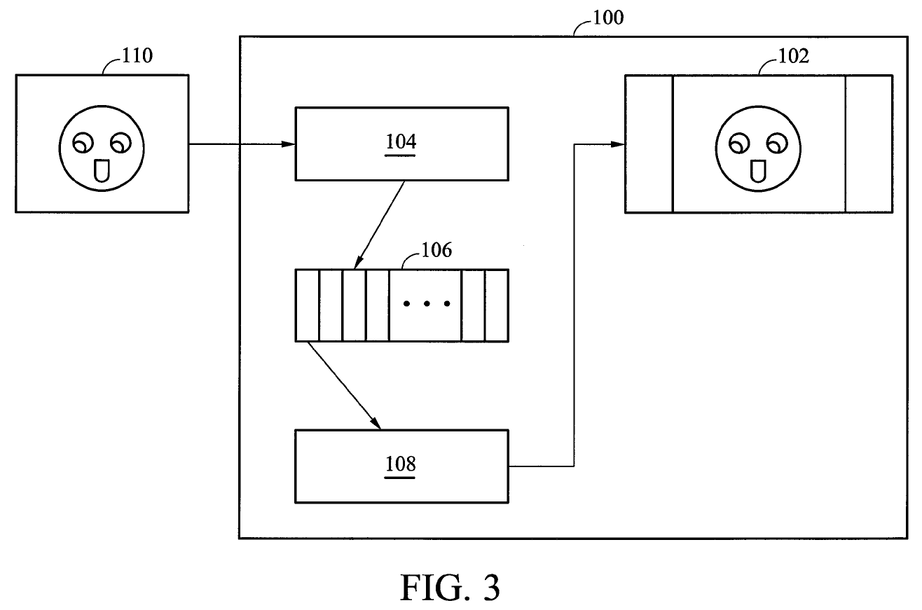

FIG. 3 illustrates an image display system 100 according to embodiments of the invention, comprising a display 102, a buffer 106, a processing unit 104 and a display driver.

Display 102 comprises dots arrayed in rows and lines with each line therein comprising several dots.

Buffer 106 comprises a plurality of memory units, each capable of storing one data item to drive one dot on the display 102.

Processing unit 104 receives a video signal corresponding to, for example, image 110 in FIG. 3. Image 110 consists of original data items of original dots arrayed in lines and rows. The original data items are transmitted line by line to processing unit 104. To perform format transformation, picture resizing, or other image functions, processing unit 104 processes original data items in a line to generate processed data items. Based on required image function, the amount of processed data items in a line may or may not exceed that of original data items in a line. If display 102 has a line resolution higher than image 110, the processed data items may be generated by merging or sampling the original data items. The processed data items may be sequentially written to buffer 106.

Display driver 108 sequentially reads the processed data items stored in memory units of buffer 106 to drive corresponding dots in a corresponding line on display 102.

Buffer 106 in image display system 100 can be smaller than a conventional line buffer, such that the embodiments can deploy fewer memory units than the total number of processed data items in a line. Furthermore, the number of processed data items in a line can be twice or four times the number of memory units.

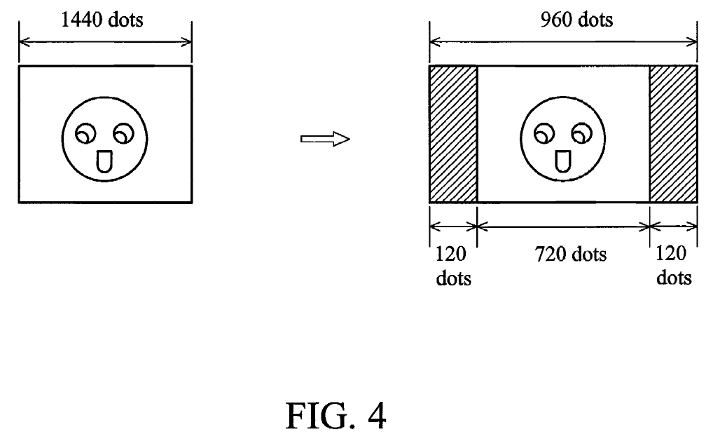

Hereinafter, a 4:3 resolution image with 1440 (dot) data items per line and a 16:9 display with 960 dots per line as illustrated in FIG. 4 are used as an illustrative, but not limitative, example to explain the timing of memory writing and reading. The central portion of the display with a width of 720 dots displays a zoomed 4:3 resolution image and the two frame borders beside the central portion show a constant color of black.

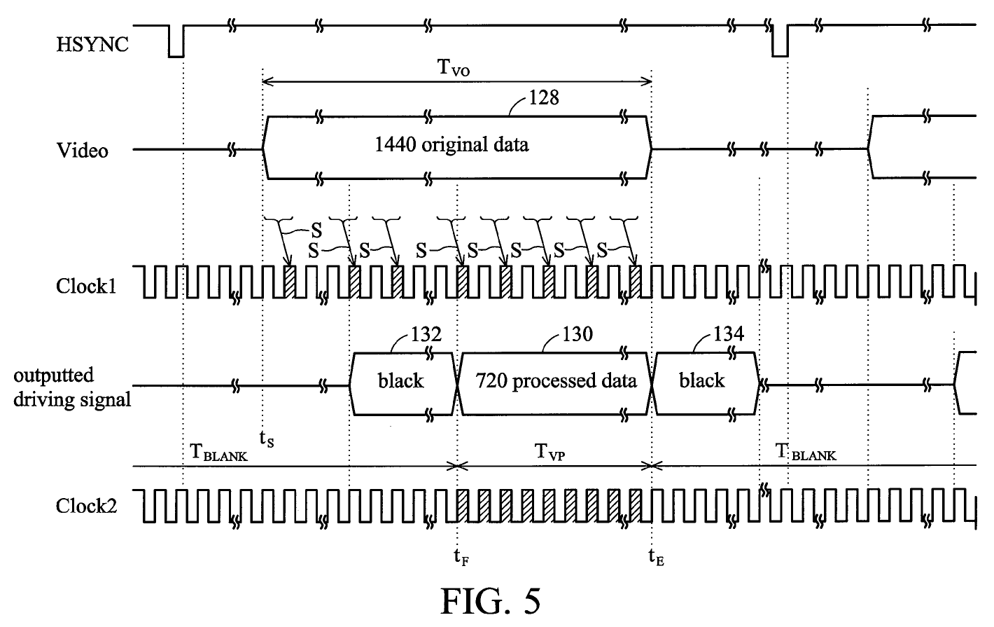

FIG. 5 is a timing diagram for signals according to embodiments of the invention. The signals shown in FIG. 5 are, from top to bottom, horizontal synchronization signal HSYNC, video signal Videos clock signal Clock1, output driving signal, and clock signal Clock2. Clock signals Clock1 and Clock2 are the same signal but have different marks thereon only for technical explanatory purposes. Horizontal synchronization signal HSYNC and video signal Video are generated according to a 4:3 resolution image and input into image display system 100. Horizontal synchronization signal HSYNC switches from low (a disserted condition) to high (an asserted condition), meaning that video signal Video is going to carry original data items for one line of a 4:3 resolution image. Thus, video signal Video, during the 1440 clocks of period T_{VO}, sequentially sends 1440 original data items 128 to image display system 100.

As discussed, the line resolution difference between a 4:3 resolution image and a 16:9 display makes it impossible to drive display 102 directly using original data items 128. Original data items 128 must be processed to perform a zoom function and generate processed data items. Each line in the 4:3 resolution image has 1440 original data items while each line in the 16:9 display has 720 dots corresponding to the 1440 original data items, causing a dot ratio of 1440:720(=2:1). In other words, a processed data item for driving a dot in the 16:9 display is the combination result of two corresponding original data items from the 4:3 resolution image. The combination result may be selected from one of the two corresponding original data items, the average of the two corresponding original data items, or any result after similar manipulation. After processing, the 720 processed data items correspond to the 1440 original data items.

The S symbols in FIG. 5 show writing actions in which 720 processed data items are sequentially written to buffer 106 in the period T_{VO} of 1440 clocks. As buffer 106 is written to once when receiving every two original data, one of every two clocks in clock signal Clock1 after time tₛ is marked with slashes to represent an effectively writing clock. It can be found in FIG. 5 that the writing rate of the processed data is one half of a processed data item per clock.

Display driver 108 sequentially reads the processed data items stored in buffer 106 to generate a driving signal for driving corresponding dots on display 102. To display a 4:3 resolution image on a 16:9 display, the driving signal includes not only the 720 processed data items 130, but also two sets of black data items for driving the dots inside two frame borders. Each set of the black data items has 120 black (dot) data items.

In FIG. 5, the end points of reading the 720 processed data items from buffer 106 and writing the 720 processed data items to buffer 106 are substantially the same. This arrangement results in the minimum size of buffer 106 being dramatically reduced.

The clocks with slashes in clock signal Clock2 represent effectively reading clocks, clocks when buffer 106 is read. As shown in FIG. 5, during period T_{VP} starting from time t_{F}, display driver 108 spends 720 clocks to read 720 processed data items in buffer 106. Therefore, the reading rate of the processed data items from buffer 106 is one per clock.

It can be derived from FIG. 5 that the size of buffer 106 need not be the same as that for storing all the processed data items. In fact, the size of buffer 106 need only be large enough to store all the processed data items generated during the time period from t_{S} to t_{F}. After time t_{F}, since the reading rate exceeds the writing rate, newly generated processed data items can be stored in memory units that have been read. Namely, in a line period, memory units in a buffer can be repetitively written to or read. In the embodiment, there are 720 clocks between time t_{S} and time t_{F}, such that 360 processed data items will be generated therebetween. Therefore, buffer 106 only requires a minimum of 360 memory units, each storing one processed data item. The total number of the processed data items is 720, about twice the number of memory units, 360.

Even though FIG. 5 shows that writing and reading of buffer 106 end at exactly the same time, this condition is only illustrative. As is understood in the art, a processed data item must first be written to memory, and then it can be read. Therefore, the ending of writing a memory unit in buffer 106 must be at least one clock ahead of that of reading the memory unit. In the embodiments of the invention, if the ending of writing is 10 or fewer clocks ahead of that of reading, or there are fewer than 10 processed data items remain unread after the ending of writing, the writing and the reading end at substantially the same time.

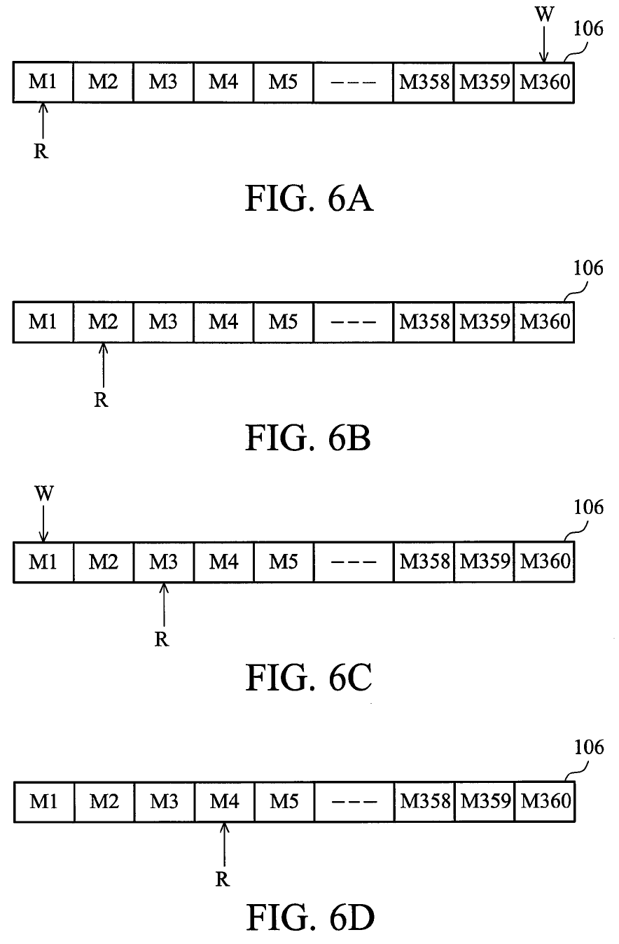

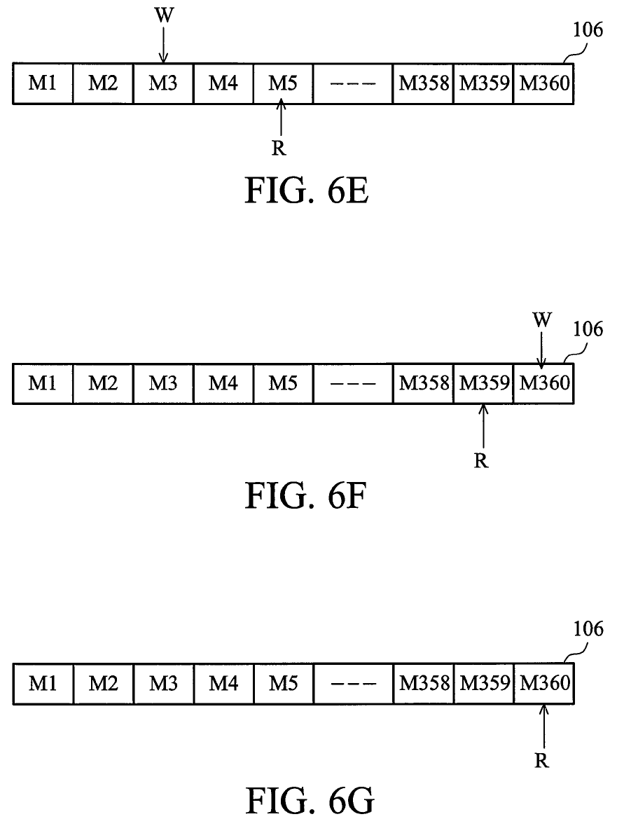

FIGS. 6A to 6G show at different clocks a buffer 106 with only 360 memory units while there are totally 720 processed data items. Pointers R and W in FIGS. 6A-6G point at currently read and written memory units, respectively.

FIG. 6A shows that memory units M1-M359 have been written such that the 360^{th} processed data item is currently written to memory unit M360. In the meantime, the 1^{st} processed data item in memory unit M1 is read out. FIG. 6A also shows that reading the processed data items starts about the time when half of the processed data items have been written to the memory units.

The time of FIG. 6B is one clock behind that of FIG. 6A. Because the writing rate is one half of one processed data item per clock, there is no pointer W in FIG. 6B, implying there is no writing in this clock. Analogously, as the reading rate is one processed data item per clock, pointer R in FIG. 6B proceeds to point at memory unit M2, reading out the 2^{nd} processed data item.

The time of FIG. 6C is one clock behind that of FIG. 6B. Pointer W reappears in FIG. 6C, pointing at memory unit M1. Since memory unit M1 has been read two clocks before and is currently idle, it can be recycled to store a newly generated processed data item, the 361^{st} processed data item. As the reading rate is one processed data item per clock, pointer R in FIG. 6C further proceeds to point at memory unit M3 and read out the 3^{rd} processed data item.

The time of FIG. 6D is one clock behind that of FIG. 6C, and is one clock ahead of that of FIG. 6E. It is comprehensible from FIGS. 6A to 6D that pointer R proceeds to a following memory unit every clock and pointer W does every two clocks.

Every time when pointer R/W points at the last memory unit, memory M360, pointer R/W restarts and points at the first memory unit, memory unit M1, in the next effectively reading/writing clock.

As shown in FIG. 6F, during the last effectively writing clock, the last processed data item, the 720^{th} processed data item, is written to memory unit M360 while the 719^{th} processed data item currently stored in memory unit M359 is read, as shown in FIG. 6F.

The time of FIG. 6G is one clock behind that of FIG. 6F, showing, during the last effectively reading clock, no pointer W, but pointer R pointing at memory unit M360 to read the 720^{th} processed data item. FIGS. 6F and 6G also illustrate that the writing and the reading of buffer 106 end at substantially the same time since the endings thereof are only one clock apart.

As shown by FIGS. 5 and 6A-6G, buffer 106 needs only 360 memory units to store 720 processed data items.

The embodiment shown in FIGS. 5 and 6A-6G reads at twice a writing rate. The invention is also applicable when a reading rate is higher than, but not an integer-multiple of, the writing rate.

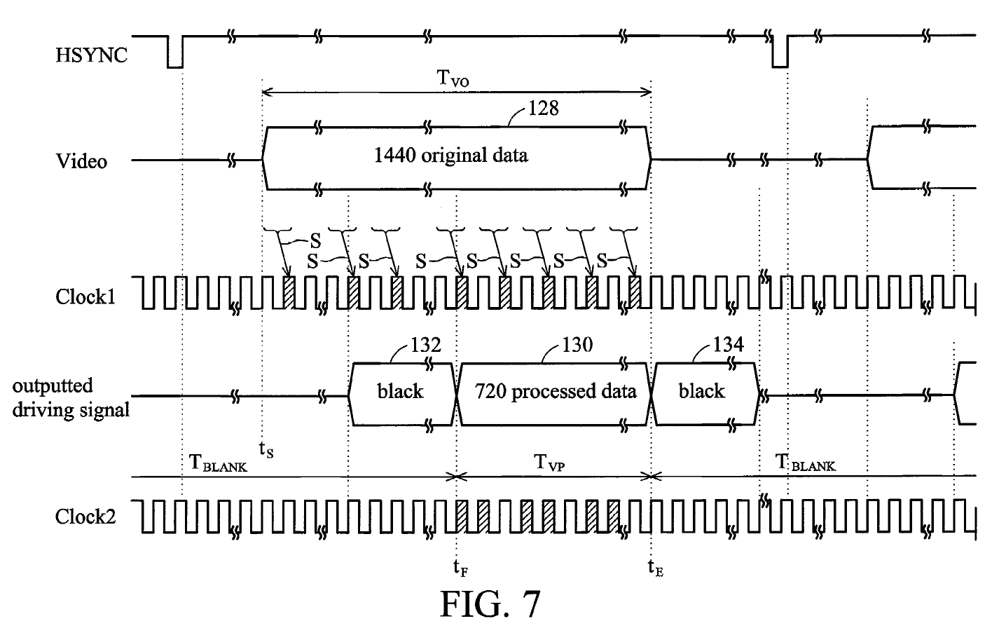

Similar to FIG. 5, FIG. 7 shows a timing diagram for signals according to embodiments of the invention. Unlike FIG. 5, two of every three clocks during period T_{VP} starting from time T_{F} are marked as effectively reading clocks. In other words, the reading rate is ⅔ processed data item per clock while the writing rate is ½ processed data item per clock. As there are 720 process data items required to read, period T_{VP} lasts 1080(=720*3/2) clocks. It can be derived from FIG. 7 that 360(=1440−1080) clocks are between time t_{S} and time t_{F}, generating only 180(=360/2) processed data items each requiring an individual memory unit for storing. If solely following the time diagram in FIG. 7 where reading the processed data 130 starts about the time when a quarter of the processed data items have been written to memory units, the size of the buffer can be 180, a quarter of the number of the total processed data items, 720. To prevent the conflict when reading and writing are performed to the same memory unit, the ending of reading in FIG. 7 can be deferred until n clocks behind the ending of writing in FIG. 7, such that the buffer is required to have at least (180+n/2) memory units. As defined, if the ending of writing is 10 or less clocks ahead of that of reading, or there are less than 10 processed data items unread after the ending of writing, the writing and the reading end at substantially the same time.

In the disclosed embodiments, writing and reading end at substantially the same time, such that the buffer size can be a half or quarter of the number of the total processed data items.

As shown in FIGS. 5 and 7, the minimum size of a buffer is determined by the number of the processed data items generated during the time period from t_{S} to t_{F}. The narrower the time period from t_{S} to t_{F}, the smaller the size of the buffer. As shown in FIGS. 5 and 7, the locations of time t_{S} and time t_{E} are unchangeable because they are determined by input video signal Video. Reading rate can be slowed to lengthen period T_{VP}, making t_{F} closer to t_{S}. However, if, in a line period, the time period outside period T_{VP} is defined as period T_{BLANK}, lengthening period T_{VP} is equivalent to shortening period T_{BLANK}. For a LCD display, period T_{BLANK} must be sufficiently long such that dots in frame borders can be driven to show black and some driving preparations, such as pre-charging or V_{COM} inversion, can be made. Therefore, period T_{BLANK} cannot be too short.

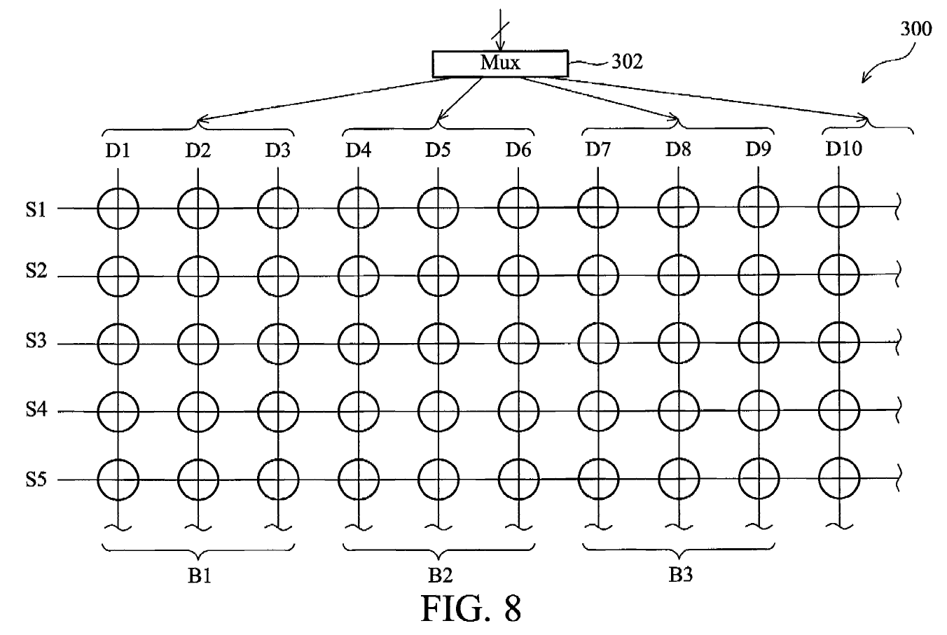

FIGS. 5 and 7 show embodiments wherein only one processed data item is read during one effectively reading clock. The invention is not limited thereto, but more than one processed data items can be read at a time during one effectively reading clock. FIG. 8 shows a display 300 applicable to the invention. Display 300 has scan lines S1-S5 and data lines D1-D10. One scan line crosses one data line to control a corresponding dot at about the cross area. Data lines D1-DL0 are not driven simultaneously. As shown in FIG. 8, three adjacent data lines are collectively named as a bank and three banks B1-B3 are shown in FIG. 8. Multiplexer 302 selects one of the banks such that the three data lines in the selected bank are simultaneously driven. For display 300 in FIG. 8, three processed data items need be simultaneously read during one effectively reading clock to drive three data lines.

The buffers in the embodiments of the invention can be smaller than the total number of the processed data items in a line, such as a half or quarter thereof. An image display system according to embodiments of the invention is less costly and thus more favorable in market behavior.

While the invention has been described by way of examples and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing method, comprising:
receiving a video signal with original data items of original dots, wherein all original dots construct one line of an image;
processing the original data items to perform a zoom function and generate processed data items;
writing the processed data items into memory units of a buffer; and
before all the processed data items are written to the memory units, sequentially reading the processed data items stored in the memory units to drive corresponding dots in a line on a display;
wherein the time when all the processed data items stored in the memory units have been read ends at substantially the same time as that when all the processed data items have been written to the memory units.

2. The image processing method of claim 1, wherein reading of the processed data items starts about the time when half of the processed data items have been written to the memory units.

3. The image processing method of claim 1, wherein reading of the processed data items starts about the time when a quarter of the processed data items have been written to the memory units.

4. The image processing method of claim 1, wherein the number of the processed data items exceeds the number of the memory units.

5. The image processing method of claim 4, wherein, after the last memory unit has been written to and the first memory unit read, one of the processed data items is written to the first memory unit.

6. The image processing method of claim 1, wherein the processed data items are written to memory units at a writing rate and read from memory units at a reading rate, and the reading rate is an integer-multiple of the writing rate.

7. The image processing method of claim 1, wherein the processed data items are written to the memory units at a writing rate and read from the memory units at a reading rate, and the reading rate is not an integer-multiple of the writing rate.

8. The image processing method of claim 1, further comprising driving dots in frame borders in the line to display a predetermined color after all the processed data items are read from the memory units or before any of the processed data item is read from the memory units.

9. An image display system, comprising:
a display with lines, each line having dots;
a buffer with memory units;
a processing unit receiving a video signal with original data items of original dots, processing the original data items to perform a zoom function and generate processed data items, and writing the processed data items to the memory units, wherein all original dots construct one line of an image; and
a display driver, sequentially reading the processed data items stored in the memory units to drive corresponding dots in a corresponding line on the display;
wherein the number of all the processed data items exceeds the number of the memory units.

10. The image display system of claim 9, wherein the time when all the processed data items stored in the memory units are read by the display driver ends at substantially the same time as that when all the processed data items are written to the memory units by the processing unit.

11. The image display system of claim 9, wherein the display driver drives dots within a frame border in the corresponding line to display a predetermined color after all the processed data items are read from the memory units or before any of the processed data items is read from the memory units.

12. The image display system of claim 9, wherein the number of the processed data items is about twice the number of the memory units.

13. The image display system of claim 9, wherein the number of the processed data items is about four times the number of the memory units.

14. The image display system of claim 9, wherein the processed data items are written to the memory units at a writing rate and read from the memory units at a reading rate, and the reading rate is an integer-multiple of the writing rate.

15. The image display system of claim 9, wherein the processed data items are written to the memory units at a writing rate and read from the memory units at a reading rate, and the reading rate is not an integer-multiple of the writing rate.
